(19) United States
(12) Patent Application Publication
(10) Pub. No.: US 2014/0039789 A1
(43) Pub. Date: Feb. 6, 2014

(54) DYNAMIC PROGRESSIVE MAP GRANULARITY FOR NAVIGATION

(71) Applicants: Denise A. Bell, Austin, TX (US); Travis Grigsby, Austin, TX (US); Jana Jenkins, Raleigh, NC (US); Trevor Livingston, Austin, TX (US)

(72) Inventors: Denise A. Bell, Austin, TX (US); Travis Grigsby, Austin, TX (US); Jana Jenkins, Raleigh, NC (US); Trevor Livingston, Austin, TX (US)

(73) Assignee: International Business Machines Corporation, Armonk, NY (US)

(21) Appl. No.: 13/567,333

(22) Filed: Aug. 6, 2012

(51) Int. Cl. G01C 21/34; G01C 21/36

(52) U.S. Cl. 701/428; 701/400; 701/468; 701/533

(57) ABSTRACT

Embodiments of the present invention provide a method, system and computer program product for dynamic, progressive route granularity for a computed route in a navigation system. In an embodiment of the invention, a method for dynamic, progressive routing granularity for a computed route in a navigation system is provided. The method includes computing a route of turn by turn directives from an origin to a destination in memory of a navigation computing system. The method additionally includes determining one segment of the route from amongst multiple different segments of the route to be a familiar segment. The method yet further includes removing from the familiar segment at least one of the turn by turn directives. Finally, the method includes displaying the route in the navigation computing system without segments that have been removed as part of the familiar segment.

### BACKGROUND OF THE INVENTION

1. Field of the Invention

The present invention relates to navigation software and more particularly to navigation data granularity during navigation.

2. Description of the Related Art

Navigation refers in some part to the selection of a geographical origin and a geographical destination and computing one or more routes across which one might find their way from the origin to the destination. Along each route, different points of interest may be computed along with other relevant and sometimes irrelevant information pertaining to different points along the computed route. Way points can be established for each route as a way in which first to direct the navigation logic to adapt to a specific geographical position along the way from the origin to the destination, and second to influence the computation of the route itself. As it is well known, classical navigation software can integrate a global positioning system (GPS) in order to integrate the positioning of an individual or vehicle into the computation of the route and the presentation of navigation data, and provides both turn by turn instructions textually, graphically, audibly or any combination thereof, as well as a view to a map with the route.

The viewable map provided by mapping software can be presented in a number of ways. A traditional two-dimensional or three-dimensional map with a route overlay can be displayed typically as a thick line in bolded coloring can be provided. Generally, the map can be zoomable so that detail of a particular point along the route can be displayed at the expense of other points on the route. Further, the basic map of the route can be displayed concurrently with a separate display of a visualization of just an approaching navigation directive such as a “turn ahead”. In this way, an end user can visualize the entire route in one portion of a viewing screen while also visualizing a next turn instruction. This dual display assists the end user in understanding the context of the approaching navigation directive with regard to the route as a whole.

Of note, the granularity of navigation directives presented to the end user is fixed in classical navigation software to a most atomic level of every maneuver required to stay in line with the route. That is to say, for every turn required in a route, a navigation directive is presented. Accordingly, in some respects, navigation route computation can be highly inefficient when used by a person familiar generally with a particular segment of the route. For example, most end users know the best route from their home to the nearest highway, but lack knowledge of the neighborhood nearest a destination. Yet classical navigation software would compute turn by turn navigation directives for every turn on a route from the home of the end user to the destination including those navigation directives required from the home of the end user to the highway en route to the destination.

### BRIEF SUMMARY OF THE INVENTION

Embodiments of the present invention address deficiencies of the art in respect to route computation in a navigation system and provide a novel and non-obvious method, system and computer program product for dynamic, progressive route granularity for a computed route in a navigation system. In an embodiment of the invention, a method for dynamic, progressive routing granularity for a computed route in a navigation system is provided. The method includes computing a route of turn by turn directives from an origin to a destination in memory of a navigation computing system. The method additionally includes determining one segment of the route from amongst multiple different segments of the route to be a familiar segment. The method yet further includes removing from the familiar segment at least one of the turn by turn directives. Finally, the method includes displaying the route in the navigation computing system without segments that have been removed as part of the familiar segment.

In one aspect of the embodiment, the familiar segment is bounded by two different waypoints, one of the waypoints being a home location of an end user and another of the waypoints being a freeway entrance. In another aspect of the embodiment, the familiar segment can include turn by turn directives within a pre-configured radius of a home location of an end user. In yet another aspect of the embodiment, the familiar segment is computed as all turn by turn directives between a location pre-configured as familiar and a freeway entrance. In even yet another aspect of the embodiment, the navigation computing system is a global positioning system (GPS) navigation computing system.

In another embodiment of the invention, a navigation computing system can be configured for dynamic, progressive routing granularity for a computed route. The system can include a host computer comprising at least one processor and memory and a map data store coupled to the host computer. The system also can include a navigation application executing in the memory of the host computer and computing routes of turn by turn directives for specified origins and corresponding destinations using map data disposed in the map data store. Finally, the system can include a dynamic route granularization module coupled to the navigation application. The module can include program code enabled to determine one segment of a computed one of the routes from amongst multiple different segments of the computed one of the routes to be a familiar segment, to remove from the familiar segment at least one of the turn by turn directives, and to display the route in a display of the host computer without segments that have been removed as part of the familiar segment.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamic, progressive routing granularity for a computed route in a navigation system;

FIG. 2 is a schematic illustration of a navigation data processing system configured to perform dynamic, progressive routing granularity for a computed route; and,

FIG. 3 is a flow chart illustrating a process for dynamic, progressive routing granularity for a computed route in a navigation system.

### DETAILED DESCRIPTION OF THE INVENTION

Embodiments of the invention provide for dynamic, progressive routing granularity for a computed route in a navigation system. In accordance with an embodiment of the invention, a route can be computed in memory of a computer navigation system from an origin to a destination. The route can be computed to include different dominant way points, for instance connections between different travel pathways such as roads, streets and avenues. Turn by turn navigation directives can be computed for some segments of the route between different way points, but turn by turn instructions in at least one segment between two of the way points can be omitted in favor of a simple navigation directive indicating the required navigation to the second way point from the first way point. For example, a segment of a route in a geographic area likely to be familiar to an end user can be subjected to the simple navigation directive while remaining portions of the route can be subjected to turn by turn navigation directives. In this way, the granularity of navigation directives from a most granular level to a least granular level can co-exist in a single computed route.

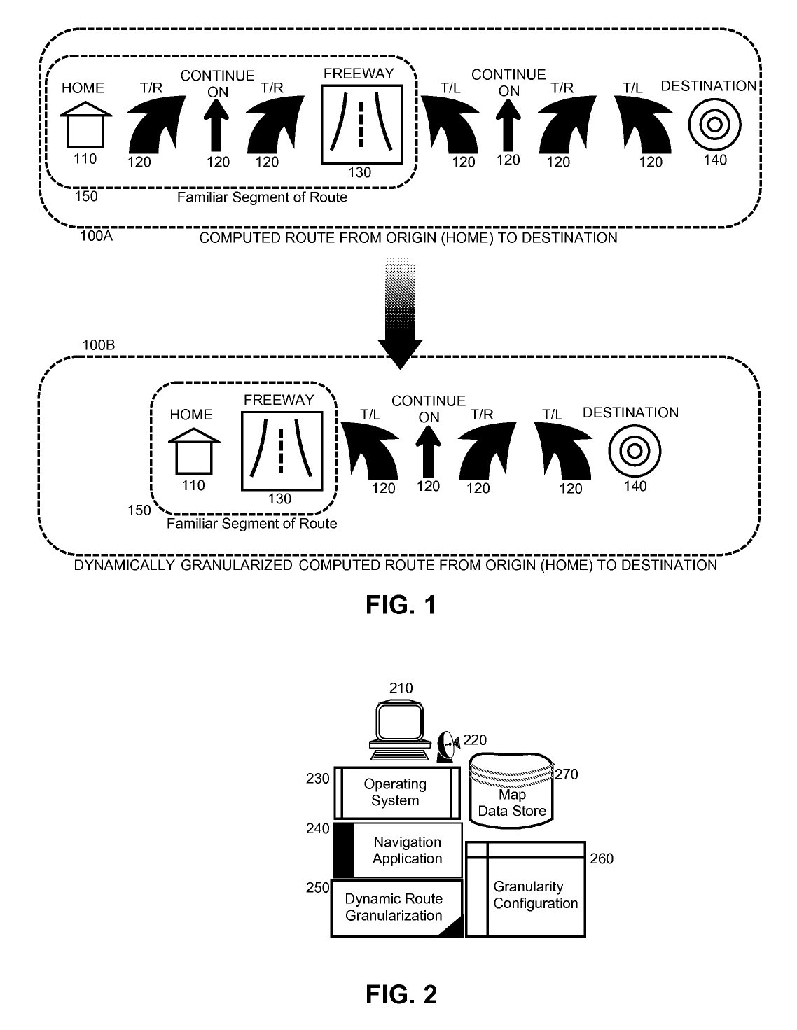

In further illustration, FIG. 1 is a pictorial illustration of a process for dynamic, progressive routing granularity for a computed route in a navigation system. As shown in FIG. 1, a route 100A of turn by turn directives 120 can be computed for a trip from an origin 110 to a destination 140. At least one familiar segment 150 can be determined for the route 100A, for example a portion of the route between a well known way point 130 like a freeway entrance and one's home 110, or more simply a segment of a freeway between an entrance ramp at one location along the route 110A and an exit ramp at another location along the route 110A. Thereafter, the familiar segment 150 can be de-granularized removing interim turn by turn directives 120 within the route 100A to produce a dynamically granularized computed route 100B. Optionally, when displayed in a user interface of a navigation system or mapping application, the familiar segment 150 upon activation can be expanded to include a granular view of the familiar segment 150 including the interim turn by turn directives 120 within the familiar segment of the route 150.

The process described in connection with FIG. 1 can be implemented within a navigation data processing system. In yet further illustration, FIG. 2 schematically shows a navigation data processing system configured to perform dynamic, progressive routing granularity for a computed route. The system can include a host computer 210 with at least one processor and memory and a GPS receiver 220 coupled thereto. The host computer 210 can support the execution of an operating system 230 which in turn can support the execution of a navigation application 240. The navigation application 240 can be configured to generate a route of turn by turn directives based upon a provided origin and a provided destination using geographic data stored within map data store 270.

Of note, a dynamic route granularization module 250 an be coupled to the navigation application 240. The module 250 can include program code enabled upon execution in the memory of the host computer 210 to identify within a computed route at least one familiar segment. The familiar segment can be computed based upon the proximity of different way points in the familiar segment to a home location of an end user stored in granularity configuration 260. Alternatively, the familiar segment can be computed based upon binding waypoints of known familiar locations such as the home of the end user and a highway entrance, or the entrance and exit of a particular highway or sequence of highways in the route. As yet another alternative, known locations can be stored in the granularity configuration 260 and when two stored waypoints known to be familiar appear within the route, the segment bounded by the stored waypoints can be determined to be a familiar segment. Once a familiar segment has been computed, the turn by turn directives within the familiar segment can be removed from display of the route and the route, without the removed turn by turn directives can be displayed to the end user by navigation application 240.

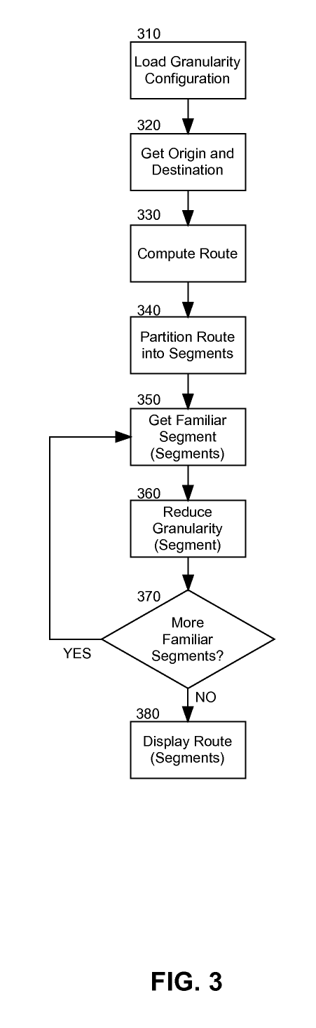

In even yet further illustration of the operation of the dynamic route granularization module 300, FIG. 3 is a flow chart illustrating a process for dynamic, progressive routing granularity for a computed route in a navigation system. Beginning in block 310, a granularity configuration can be retrieved for an end user and in block 320, both an origin and a destination can be received for plotting a route from the origin to the destination. In block 330, the route can be computed based upon the origin and the destination. Of note, in block 340 the route can be partitioned into segments, for example as defined by different substantial waypoints including freeway entrance and exits, major intersections, and pre-specified locations including the home of an end user, previously visited locations, the workplace of an end user or the home of a relative or close friend, the school of an end user and the like.

In block 350, a first of the segments can be selected as a familiar segment indicative of familiarity of the locale within which the selected segment resides. An example would include all segments falling within a specified radius of a pre-specified familiar location such as the home or workplace of an end user. In block 360, the selected familiar segment can be reduced in granularity by removing any number of turn by turn navigation directives disposed within the familiar segment. Thereafter, in decision block 370 it can be determined whether or not additional ones of the segments of the route are familiar segments. If so, the process can repeat through block 350. In decision block 370 when no further segments in the route are determined to be familiar segments, in block 380 the route can be displayed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for dynamic, progressive routing granularity for a computed route in a navigation system, the method comprising:
computing a route of turn by turn directives from an origin to a destination in memory of a navigation computing system;
determining one segment of the route from amongst multiple different segments of the route to be a familiar segment;
removing from the familiar segment at least one of the turn by turn directives; and,
displaying the route in the navigation computing system without segments that have been removed as part of the familiar segment.

2. The method of claim 1, wherein the familiar segment is bounded by two different waypoints, one of the waypoints being a home location of an end user and another of the waypoints being a freeway entrance.

3. The method of claim 1, wherein the familiar segment comprises turn by turn directives within a pre-configured radius of a home location of an end user.

4. The method of claim 1, wherein the familiar segment is computed as all turn by turn directives between a location pre-configured as familiar and a freeway entrance.

5. The method of claim 1, further comprising displaying at least one removed turn by turn directive in a familiar segment responsive to an activation of a display of the familiar segment.

6. The method of claim 1, wherein the navigation computing system is a global positioning system (GPS) navigation computing system.

7. A navigation computing system configured for dynamic, progressive routing granularity for a computed route, the system comprising:
a host computer comprising at least one processor and memory;
a map data store coupled to the host computer;
a navigation application executing in the memory of the host computer and computing routes of turn by turn directives for specified origins and corresponding destinations using map data disposed in the map data store; and,
a dynamic route granularization module coupled to the navigation application, the module comprising program code enabled to determine one segment of a computed one of the routes from amongst multiple different segments of the computed one of the routes to be a familiar segment, to remove from the familiar segment at least one of the turn by turn directives, and to display the route in a display of the host computer without segments that have been removed as part of the familiar segment.

8. The system of claim 7, wherein the familiar segment is bounded by two different waypoints, one of the waypoints being a home location of an end user and another of the waypoints being a freeway entrance.

9. The system of claim 7, wherein the familiar segment comprises turn by turn directives within a pre-configured radius of a home location of an end user.

10. The system of claim 7, wherein the familiar segment is computed as all turn by turn directives between a location pre-configured as familiar and a freeway entrance.

11. The system of claim 7, wherein the program code of the module displays at least one removed turn by turn directive in a familiar segment responsive to an activation of the familiar segment in the display.

12. The system of claim 7, wherein the host computer is a global positioning system (GPS) navigation computing system.

13. A computer program product for dynamic, progressive routing granularity for a computed route in a navigation system, the computer program product comprising:
a computer readable storage medium having computer readable program code embodied therewith, the computer readable program code comprising:
computer readable program code for computing a route of turn by turn directives from an origin to a destination in memory of a navigation computing system;
computer readable program code for determining one segment of the route from amongst multiple different segments of the route to be a familiar segment;
computer readable program code for removing from the familiar segment at least one of the turn by turn directives; and,
computer readable program code for displaying the route in the navigation computing system without segments that have been removed as part of the familiar segment.

14. The computer program product of claim 13, wherein the familiar segment is bounded by two different waypoints, one of the waypoints being a home location of an end user and another of the waypoints being a freeway entrance.

15. The computer program product of claim 13, wherein the familiar segment comprises turn by turn directives within a pre-configured radius of a home location of an end user.

16. The computer program product of claim 13, wherein the familiar segment is computed as all turn by turn directives between a location pre-configured as familiar and a freeway entrance.

17. The computer program product of claim 13, further comprising computer readable program code for displaying at least one removed turn by turn directive in a familiar segment responsive to an activation of a display of the familiar segment.

18. The computer program product of claim 13, wherein the navigation computing system is a global positioning system (GPS) navigation computing system.
